(19) United States
(12) Patent Application Publication
(10) Pub. No.: US 2005/0270699 A1
(43) Pub. Date: Dec. 8, 2005

(54) Ramp member of variable inclination angle in recording disk drive

(75) Inventor: Shinichi Takahashi, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/967,221

(22) Filed: Oct. 19, 2004

(30) Foreign Application Priority Data
Jun. 8, 2004 (JP) 2004-169562

(51) Int. Cl. G11B 21/22

(52) U.S. Cl. 360/254

(57) ABSTRACT

First and second guiding passages are defined in a ramp member. The first guiding passage extends along a first inclined plane intersecting with a reference plane by a first inclined angle. The second guiding passage extends along a second inclined plane intersecting with the reference plane by a second inclined angle larger than the first inclined angle. The first guiding passage serves to prevent collision between a recording disk and a head slider in a recording disk drive. The second guiding passage serves to enable a short-distance movement of the head slider on the ramp member. The boundary of a data zone can be located closest to the outer periphery of the recording disk.

### BACKGROUND OF THE INVENTION

1. Field of the Invention

The present invention relates to a recording disk drive such as a hard disk drive (HDD). In particular, the invention relates to a recording disk drive comprising: a recording disk; and a ramp member fixed at a location outside the recording disk.

2. Description of the Prior Art

In a so-called load/unload mechanism, a load tab is fixed to the tip end of a head actuator supporting a head slider. A ramp member is fixed at a location outside a magnetic recording disk on the path of movement of the load tab. When the magnetic recording disk stands still, the load tab is received on the ramp member. The head slider can thus be held at a position outside the magnetic recording disk.

A guiding passage is defined on the ramp member. The guiding passage extends in the radially outward direction of the magnetic recording disk. A slope is defined on the guiding passage so as to get remoter from the magnetic recording disk in the radially outward direction of the magnetic recording disk. When the head slider moves toward the ramp member, the load tab first contacts the slope. When a swinging movement of the head actuator allows the load tab to climb up the slope, the tip end of the head actuator gets remoter from the magnetic recording disk. On the other hand, when the head slider starts flying, the load tab moves down the slope.

A high-pitched slope induces a rapid fall of the head slider toward the magnetic recording disk when the load tab takes off from the ramp member. The head slider often collides against the surface of the magnetic recording disk. The magnetic recording disk suffers from damages. On the other hand, a low-pitched slope requires a long-distance movement of the load tab until the head slider is released from the negative pressure influenced from the rotating magnetic recording disk when the head slider is drive outside. In this case, the front end of the slope deeply penetrate into a space above the surface of the magnetic recording disk, so that the area is reduced for the data zone.

### SUMMARY OF THE INVENTION

It is accordingly an object of the present invention to provide a recording disk drive capable of preventing damages of a recording disk without reducing the area for a data zone. It is another object of the present invention to provide a ramp member greatly useful to realize the aforementioned recording disk drive.

According to a first aspect of the present invention, there is provided a recording disk drive comprising: a recording disk; and a ramp member fixed at a location outside the recording disk, wherein said ramp member comprises: a first guiding passage extending along a first inclined plane so as to get remoter from a reference plane including the surface of the recording disk in a radially outward direction of the recording disk, said first inclined plane intersecting with the reference plane by a first inclined angle; and a second guiding passage extending along a second inclined plane at a location outside the first guiding passage so as to get remoter from the reference plane in a radially outward direction of the recording disk, said second inclined plane intersecting with the reference plane by a second inclined angle larger than the first inclined angle.

When the recording disk stands still, the tip end of a head actuator supporting a head slider is received at an inoperative position on the ramp member. When the recording disk starts rotating, a swinging movement allows the tip end of the head actuator to move down the second guiding passage and the first guiding passage. Since the first inclined angle of the first guiding passage is set smaller than the second inclined angle of the second guiding passage, the tip end of the head actuator approaches the recording disk at a reduced speed. A further swinging movement allows the tip end of the head actuator to take off from the ramp member. The first guiding passage serves to relieve the energy of the falling tip end of the head actuator. Collision is prevented between the recording disk and the head slider. The recording disk is prevented from suffering from damages.

When the recording disk is rotating, the head slider flies above the recording disk. When read/write operation has been completed during the rotation of the recording disk, the head actuator is allowed to swing outward of the recording disk. The tip end of the head actuator thus contacts the first guiding passage. Since the first inclined angle is set smaller than the second inclined angle, the first guiding passage solely receives a smaller impact in the direction perpendicular to the first guiding passage when the tip end of the head actuator collides against the first guiding passage. Friction is prevented to the uttermost between the tip end of the head actuator and the first guiding passage. Generation of dusts can be prevented in the ramp member.

A further swinging movement of the head actuator allows the tip end of the head actuator to climb up the first guiding passage and the second guiding passage. Since the second inclined angle of the second guiding passage is set larger than the first inclined angle of the first guiding passage, the tip end of the head actuator sharply gets remoter from the surface of the recording disk. Therefore, the head slider gets remoter earlier from the surface of the recording disk.

The recording disk drive of this aspect enables a short-distance movement of the head actuator until the head slider sufficiently gets remoter from the surface of the recording disk, as compared with the case where the first and second guiding passages define a uniform slope of the first inclined angle. Therefore, the tip end of the first guiding passage can thus be located closest to the outer periphery of the recording disk. The outer boundary of the data zone can approach the outer periphery of the recording disk to the uttermost.

The second guiding passage may be connected to the outer end of the first guiding passage in the aforementioned recording disk drive. The first guiding passage may extend across the path of movement of a load tab. In this case, the path may be defined in parallel with the reference plane during flight of a head slider opposed to the recording disk.

A specific ramp member may be provided to realize the aforementioned recording disk drive. The ramp member may comprise: a first guiding passage extending backward from a given position along a first inclined plane intersecting with a reference plane by a first inclined angle, said first guiding passage designed to receive a load tab attached to the tip end of a head actuator; a second guiding passage extending along a second inclined plane at rearward of the first guiding passage, said second inclined plane intersecting with the reference plane by a second inclined angle larger than the first inclined angle; and a third guiding passage located at rearward of the second guiding passage and extending toward a depression.

According to a second aspect of the present invention, there is provided a recording disk drive comprising: a recording disk; and a ramp member fixed at a location outside the recording disk, wherein said ramp member comprises a concave surface getting remoter from the surface of the recording disk in a radially outward direction of the recording disk.

When the head slider moves toward the inoperative position outside the recording disk, the concave surface receives the approach of the tip end of the head actuator along the path providing a smaller intersection angle to the concave surface. The concave surface receives a relatively small impact from the tip end of the head actuator in the direction perpendicular to the tangent of the concave surface. Friction can thus be prevented between the tip end of the head actuator and the concave surface to the uttermost. Generation of dusts can be prevented in the ramp member.

Moreover, the concave surface bends upward to exponentially get remoter from the surface of the recording disk in the radially outward direction of the recording disk. Accordingly, the tip end of the head actuator sharply gets remoter from the surface of the recording disk. In addition, a larger inclined angle is set for the rear end of the concave surface, so that the tip end of the head actuator sharply gets remoter from the surface of the recording disk. The head slider gets remoter earlier from the surface of the recording disk. When the tip end of the head actuator moves down the concave surface, the concave surface allows the tip end of the head actuator to approach the recording disk at a reduced speed. When the tip end of the head actuator takes off from the ramp member, the energy of the falling tip end of the head actuator is relieved. The head slider is prevented from colliding against or contacting the recording disk. The recording disk can be prevented from suffering from damages.

The recording disk drive enables a short-distance movement of the tip end of the head actuator until the head slider sufficiently gets remoter from the surface of the recording disk, as compared with case where the concave surface is replaced with a single uniform slope. Therefore, the tip end of the concave surface can be located closest to the outer periphery of the recording disk. The outer boundary of the data zone can approach the outer periphery of the recording disk to the uttermost.

A specific ramp member may be provided to realize the aforementioned recording disk drive. The ramp member may comprise: a first guiding passage extending backward from a given position and designed to receive at a concave surface a load tab attached to a tip end of a head actuator; and a second guiding passage located at rearward of the first guiding passage and extending toward a depression.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the structure of a hard disk drive (HDD) as an example of a recording disk drive according to an embodiment of the present invention;

FIG. 2 is an enlarged perspective view schematically illustrating a ramp member according to a first embodiment of the present invention;

FIG. 3 is an enlarged partial vertical cross-sectional view of the ramp member for illustrating the structure of a guiding passage in detail;

FIG. 4 is an enlarged partial sectional view of the HDD, taken along the line 4-4 in FIG. 1, for schematically illustrating the structure and function of the ramp member; and

FIG. 5 is an enlarged perspective view schematically illustrating the ramp member according to a second embodiment of the present invention.

### DESCRIPTION OF THE PREFERRED EMBODIMENT

FIG. 1 schematically illustrates the inner structure of a hard disk drive (HDD) 11 as an example of a recording disk drive or storage device according to an embodiment of the present invention. The HDD 11 includes a box-shaped main enclosure 12 defining an inner space of a flat parallelepiped, for example. At least one magnetic recording disk 13 is mounted on the driving shaft of a spindle motor 14 within the main enclosure 12. The spindle motor 14 is allowed to drive the magnetic recording disk 13 for rotation at a higher revolution speed such as 5,400 rpm, 7,200 rpm, 10,000 rpm, or the like, for example. A cover, not shown, is coupled to the main enclosure 12 so as to define the closed inner space between the main enclosure 12 and the cover itself.

A data zone 17 is defined over the front and back surfaces of the individual magnetic recording disk 13 between an innermost recording track 15 and an outermost recording track 16. Concentric recording circles or tracks are defined within the data zone 17. No magnetic information is recorded on marginal zone or non-data zone 18 inside the innermost recording track 15. Likewise, no magnetic information is recorded on marginal zone or non-data zone 19 outside the outermost recording track 16.

A head actuator 21 is also accommodated in the inner space of the main enclosure 12. The head actuator 21 comprises an actuator block 22. The actuator block 22 is coupled to a vertical support shaft 23 for relative rotation. Rigid actuator arms 24 are defined in the actuator block 22 so as to extend in the horizontal direction from the vertical support shaft 23. The actuator block 22 may be made of aluminum. Molding process may be employed to form the actuator block 22.

Head suspensions 25 are fixed to the corresponding tip ends of the actuator arms 24 so as to further extend in the forward direction from the actuator arms 24. A gimbal spring, not shown, is connected to the tip end of the individual head suspension 25. A flying head slider 26 is fixed on the surface of the gimbal spring. The gimbal spring allows the flying head slider 26 to change its attitude relative to the head suspension 25. The head suspension 25 serves to urge the flying head slider 26 toward the surface of the magnetic recording disk 13.

An electromagnetic transducer, not shown, is mounted on the flying head slider 26. The electromagnetic transducer may include a read element and a write element. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example. The write element may include a thin film magnetic head designed to write magnetic bit data into the magnetic recording disk 13 by utilizing a magnetic field induced at a thin film coil pattern.

When the magnetic recording disk 13 rotates, the flying head slider 26 is allowed to receive airflow generated along the rotating magnetic recording disk 13. The airflow serves to generate a positive pressure or lift on the flying head slider 26. The flying head slider 26 is thus allowed to keep flying above the surface of the magnetic recording disk 13 during the rotation of the magnetic recording disk 13 at a higher stability established by the balance between the urging force of the head suspension 25 and the lift.

When the head actuator 21 is driven to swing about the vertical support shaft 23 during the flight of the flying head slider 26, the flying head slider 26 is allowed to move along the radial direction of the magnetic recording disk 13. This radial movement allows the electromagnetic transducer on the flying head slider 26 to cross the data zone 17 between the innermost recording track 15 and the outermost recording track 16. The flying head slider 26 can thus be positioned right above a target recording track on the magnetic recording disk 13. A power source such as a voice coil motor (VCM) 27 may be employed to realize the rotation of the head actuator 21, for example. The rotation of the head actuator 21 induces the swinging movement of the actuator arms 24 and the head suspensions 25.

A load tab 28 is attached to the front or tip end of the head suspension 25 so as to further extend in the forward direction from the head suspension 25. The load tab 28 is allowed to move in the radial direction of the magnetic recording disk 13 based on the swinging movement of the head actuator 21. A ramp member 29 is located outside the magnetic recording disk 13 on the path of movement of the load tab 28. The tip end of the ramp member 29 is opposed to the non-data zone 19 outside the outermost recording track 16. The combination of the load tab 28 and the ramp member 29 establishes a so-called load/unload mechanism as described later in detail. The ramp member 29 may be made of a hard plastic material, for example.

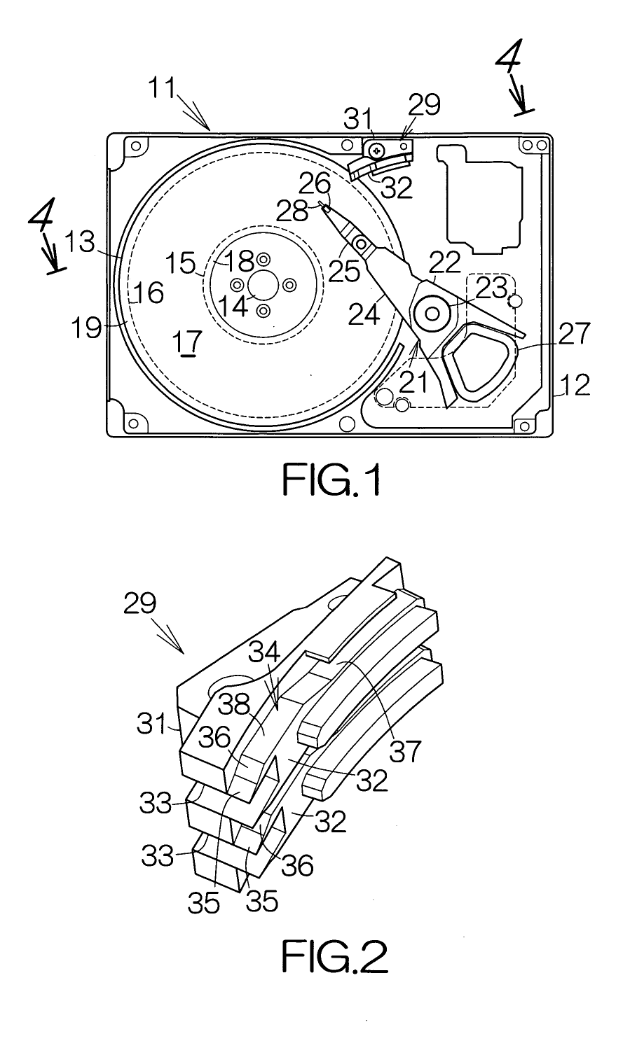

FIG. 2 schematically illustrates the structure of the ramp member 29 according to a first embodiment of the present invention. The ramp member 29 includes an attachment base 31 fixed on the main enclosure 12. The attachment base 31 may be screwed on the bottom plate of the main enclosure 12. The ramp member 29 includes ramps 32 extending from the attachment base 31 along horizontal planes toward the vertical support shaft 23 of the head actuator 21. The ramps 32 are molded for integral formation with the attachment base 31, for example. Receiving indents or grooves 33 are defined in the attachment base 31 and the individual ramps 32. The receiving indent 33 defines a space to receive insertion of the magnetic recording disk 13.

Guiding passages 34 are formed on the surface of the ramps 32. The individual guiding passage 34 extends from the inner end to the outer end in the radial or centrifugal direction of the magnetic recording disk 13 on the path of movement of the load tab 28. The guiding passage 34 comprises a first guiding passage 35 extending outward in the radial or centrifugal direction of the magnetic recording disk 13 from the inner end of the guiding passage 34. The first guiding passage 35 is designed to get remoter from the surface of the magnetic recording disk 13 in the radially outward direction of the magnetic recording disk 13. A second guiding passage 36 is connected to the uppermost or outer end of the first guiding passage 35. The second guiding passage 36 is likewise designed to get remoter from the surface of the magnetic recording disk 13 in the radially outward direction of the magnetic recording disk 13. A third guiding passage 38 is defined at a location outside the second guiding passage 36 so as to extend toward a depression 37. The third guiding passage 38 is connected to the uppermost or outer end of the second guiding passage 36.

As shown in FIG. 3, the first guiding passage 35 is defined along a first inclined plane 41. The first inclined plane 41 intersects with a reference plane 39 by a first inclined angle α. The reference plane 39 includes the surface of the magnetic recording disk 13. Likewise, the second guiding passage 36 is defined along a second inclined plane 42. The second inclined plane 42 intersects with the reference plane 39 by a second inclined angle β. The second inclined angle β is set larger than the first inclined angle α. The first inclined angle α may be set at 15 degrees approximately, for example. The second inclined angle β may be set at 22 degrees approximately, for example. The first guiding passage 35 is designed to extend across a path 43 of movement of the load tab 28. The path 43 is defined in parallel with the reference plane 39 when the flying head slider 26 is flying.

A lubricant agent may be applied to the guiding passages 34. Perfluoropolyether may be utilized as the lubricant agent, for example. The ramp member 29 may be dipped in a solution including perfluoropolyether. In addition, the lubricant agent may be impregnated in a hard plastic material before molding process. The lubricant agent serves to prevent to the uttermost generation of friction between the load tab 28 and the guiding passages 34. Generation of dusts can be prevented at the ramp member 29.

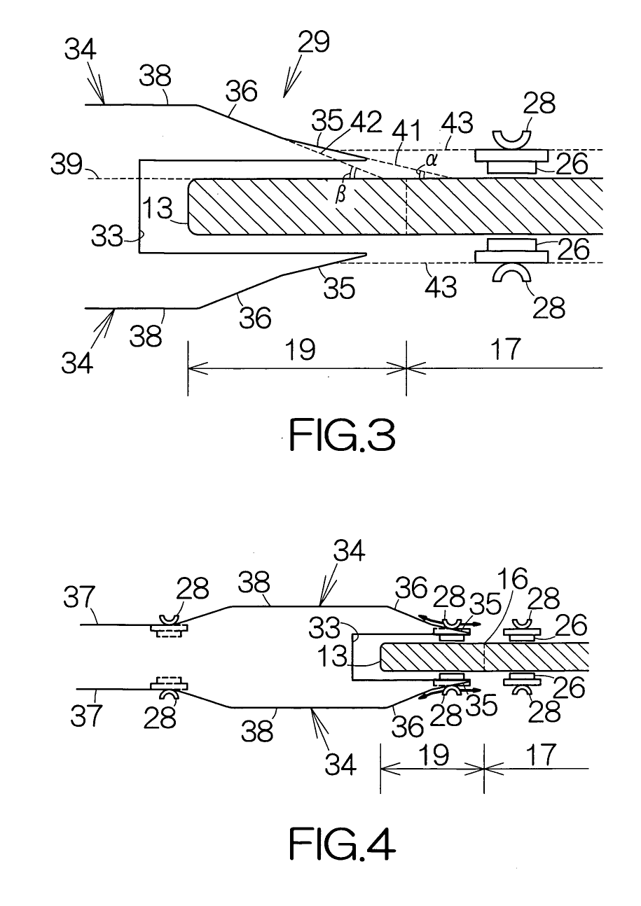

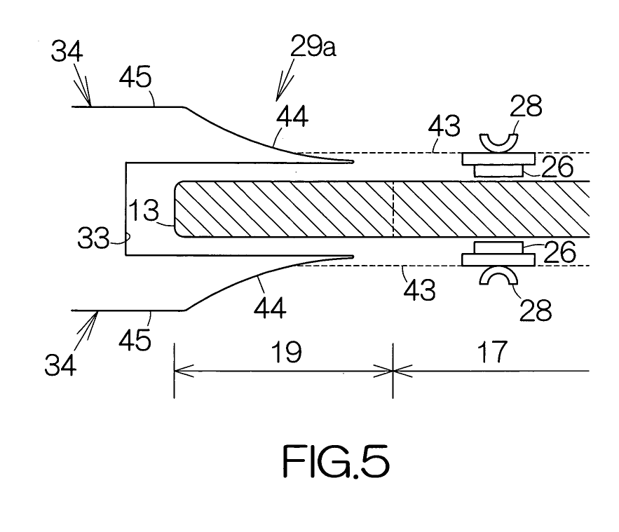

Now, assume that the magnetic recording disks 13 stop rotating. When read/write operation has been completed during the rotation of the magnetic recording disks 13, the voice coil motor 27 drives the head actuator 21 around the vertical support shaft 23 in a normal direction toward the inoperative position. The actuator arms 24 and the head suspensions 25 are driven toward a location outside the magnetic recording disks 13. As shown in FIG. 4, when the flying head sliders 26 get opposed to the non-data zones 19 or landing zone outside the outermost recording tracks 16, the load tabs 28 are allowed to contact the first guiding passages 35 of the ramps 32. Since the first inclined angle α is set small for the first guiding passage 35, the collision of the load tab 28 solely induces a smaller impact acting on the first guiding passage 35 in the direction perpendicular to the first guiding passage 35. Friction is prevented to the uttermost between the load tab 28 and the first guiding passage 35. Generation of dusts is prevented in the ramp member 29.

A further swinging movement of the actuator arm 24 allows the load tabs 28 to continuously climb up the first guiding passages 35 and the second guiding passages 36. Since the second inclined angle β of the second guiding passage 36 is set larger than the first inclined angle α of the first guiding passage 35, the load tabs 28 rushes to get remoter from the surfaces of the magnetic recording disks 13. The flying head sliders 26 get remoter earlier from the surfaces of the magnetic recording disks 13. A further swinging movement of the actuator arm 24 allows the load tabs 28 to move from the third guiding passages 38 to the depressions 37. When the load tabs 28 arrive the farthest position from the magnetic recording disks 13, the flying head sliders 24 are positioned at the inoperative position. The magnetic recording disks 13 then stop rotating. Since the load tabs 32 are reliably held on the ramp member 29, the flying head sliders 26 are prevented from colliding against or contacting the magnetic recording disks 13 even without any airflow acting on the flying head sliders 26. The flying head sliders 26 are thus effectively prevented from any attachment to a lubricant agent covering over the surfaces of the magnetic recording disks 13.

When the HDD 11 receives instructions to read or write magnetic information, the magnetic recording disks 13 start rotating. The voice coil motor 27 drives the head actuator 21 around the vertical support shaft 23 in the reverse direction opposite to the aforementioned normal direction after the rotation of the magnetic recording disk 13 has entered the steady condition. The actuator arms 24 and the head suspensions 25 move toward the rotation axis of the magnetic recording disks 13. The load tabs 28 are allowed to move out of the depressions 37 toward the third guiding passages 38. A further swinging movement of the actuator arms 24 causes the load tabs 28 to move down the second guiding passages 36 and the first guiding passages 35. Since the first inclined angle α is set relatively smaller for the first guiding passages 35, the load tabs 28 approach the magnetic recording disks 13 at a reduced speed. During the downward movement of the load tabs 28 on the first guiding passages 35, the flying head sliders 26 get opposed to the corresponding surfaces of the magnetic recording disks 13. Airflow generated along the surfaces of the magnetic recording disks 13 induces a lift on the flying head sliders 26.

Thereafter, a further swinging movement of the actuator arms 24 allows the load tabs 28 to take off from the first guiding passages 35 or ramp members 29. The first guiding passages 35 serve to relieve the energy of the falling load tabs 28. The flying head sliders 26 are thus prevented from colliding against or contacting the magnetic recording disks 13. The magnetic recording disks 13 and the flying head sliders 26 are prevented from suffering from damages. Since the magnetic recording disks 13 rotate in the steady condition, the flying head sliders 26 are allowed to fly above the surfaces of the magnetic recording disks 13 without a support from the ramp member 29.

The aforementioned HDD 11 enables a short-distance movement of the load tabs 28 until the flying head sliders 26 get remoter from the surfaces of the magnetic recording disks 13, as compared with the case where the first and second guiding passages 35, 36 continuously define a uniform slope of the first inclined angle α. The inner end of the guiding passage 34 can thus be located closest to the outer periphery of the magnetic recording disk 13. The outer boundary of the data zone 17 can approach the outer periphery of the magnetic recording disk 13 to the uttermost.

The inventor has examined the effect of the aforementioned ramp member 29. The load/unload actions were repeated three hundred thousands times. One single load/unload action included the single forward and backward movement of the flying head sliders 26 between a given flying position and the inoperative position. The first inclined angle α was set at 15 degrees in the ramp member 29. The second inclined angle β was set at 22 degrees. The revolution speed of the magnetic recording disk 13 was set at 10,000 rpm. The lubricant agent was applied over the surface of the magnetic recording disk 13. The speed of movement of the load tabs 28 was set at 0.131 [m/s] from the given flying position to the inoperative position. The speed of movement of the load tabs 28 was set at 0.260 [m/s] from the inoperative position to the given flying position. In particular, a pitch angle of the flying head sliders 26 was set at −1 degree at the inoperative position.

The inventor observed contamination in the flying head sliders 26. Adhesion of the lubricant agent was observed on the flying head sliders 26. At the same time, a scratch was observed on the magnetic recording disks 13. An electron microscope was used for observation. The examination was operated for ten samples of the ramp members 29. The magnetic recording disks 13 and the flying head sliders 26 were replaced for every individual sample.

The inventor prepared first and second comparative examples. A given single uniform slope was formed, instead of the first and second guiding passages, in ramp members according to the first comparative example. The inclined angle was set at 15 degrees. A given single uniform slope was formed, instead of the first and second guiding passages, in ramp members according to the second comparative example. The inclined angle was set at 22 degrees. Other conditions were set equal to those of the aforementioned specific examples according to the present invention.

Adhesion of the lubricant agent was not observed in any of the specific examples of the present invention and the first and second comparative examples. On the other hand, scratches were observed on the magnetic recording disk 13 for one sample of the specific example of the present invention. Likewise, scratches were observed on the magnetic recording disk in one sample of the first comparative example. Scratches were observed on the magnetic recording disk in three samples of the second comparative example. It has been proven that scratches were prevented in the surfaces of the magnetic recording disks 13 in the specific examples according to the present invention in the same manner as the first comparative examples including a uniform low-pitched slope. It has been proven that the flying head sliders 26 were prevented from colliding against the magnetic recording disks 13.

FIG. 5 schematically illustrates the structure of the ramp member 29a according to a second embodiment of the present invention. First guiding passages 44 are defined in the ramp member 29a instead of the aforementioned first and second guiding passages 35, 36. The first guiding passage 44 is designed to extend backward from the inner end of the guiding passage 34. The first guiding passage 44 includes a concave surface so as to receive the load tab 28. The concave surface is designed to get remoter from the surface of the magnetic recording disk 13 in the radially outward direction of the magnetic recording disk 13. The first guiding passages 44 are designed to extend across the paths 43 of movement of the load tabs 28 in the same manner as the first guiding passages 35. In this case, the intersection angle is set at 15 degrees approximately between the first guiding passages 44 and the path 43. A second guiding passages 45 are located at rearward of the first guiding passages 44. The second guiding passages 45 are connected to the upper most or outer end of the first guiding passages 44. The second guiding passages 45 have the structure identical to that of the aforementioned third guiding passages 38. Like reference numerals are attached to components or structures equivalent to those of the aforementioned first embodiment.

When the flying head sliders 26 move toward the inoperative position outside the magnetic recording disks 13, the first guiding passages 44 receive the approaches of the load tabs 28 along the paths providing a smaller intersection angle to the first guiding passages 44. The first guiding passages 44 receive a relatively small impact from the load tabs 28 in the direction perpendicular to the tangent of the concave surface. Friction can thus be prevented between the load tabs 28 and the first guiding passages 44 to the uttermost. Generation of dusts can be prevented in the ramp member 29a.

Moreover, the concave surface of the first guiding passage 44 bends upward to exponentially get remoter from the surface of the magnetic recording disk 13 in the radially outward direction of the magnetic recording disk 13. Accordingly, the load tab 28 sharply gets remoter from the surface of the magnetic recording disk 13. In addition, a larger inclined angle is set for the rear end of the first guiding passage 44 due to the concave surface, so that the load tab 28 sharply gets remoter from the surface of the magnetic recording disk 13. The flying head slider 26 gets remoter earlier from the surface of the magnetic recording disk 13. When the load tab 28 moves down the first guiding passage 44, the concave surface allows the load tab 28 to approach the magnetic recording disk 13 at a reduced speed. When the load tab 28 takes off from the first guiding passage 44 or ramp member 29a, the energy of the falling load tabs 28 can be relieved. The flying head sliders 26 are prevented from colliding against or contacting the magnetic recording disks 13. The magnetic recording disks 13 and the flying head sliders 26 are prevented from suffering from damages.

The aforementioned HDD 11 enables a short-distance movement of the load tabs 28 until the flying head sliders 26 get remoter from the surfaces of the magnetic recording disks 13, as compared with the case where the first guiding passages 44 define a uniform slope of the first inclined angle α. The inner end of the guiding passage 34 can thus be located closest to the outer periphery of the magnetic recording disk 13. The outer boundary of the data zone 17 can approach the outer periphery of the magnetic recording disk 13 to the uttermost.

1. A recording disk drive comprising:
a recording disk; and
a ramp member fixed at a location outside the recording disk, wherein
said ramp member comprises:
a first guiding passage extending along a first inclined plane so as to get remoter from a reference plane including a surface of the recording disk in a radially outward direction of the recording disk, said first inclined plane intersecting with the reference plane by a first inclined angle; and
a second guiding passage extending along a second inclined plane at a location outside the first guiding passage so as to get remoter from the reference plane in a radially outward direction of the recording disk, said second inclined plane intersecting with the reference plane by a second inclined angle larger than the first inclined angle.

2. The recording disk drive according to claim 1, wherein the second guiding passage is connected to an outer end of the first guiding passage.

3. The recording disk drive according to claim 1, wherein the first guiding passage extends across a path of movement of a load tab, said path being defined in parallel with the reference plane during flight of a head slider opposed to the recording disk.

4. A recording disk drive comprising:
a recording disk; and
a ramp member fixed at a location outside the recording disk, wherein
said ramp member comprises a concave surface getting remoter from a surface of the recording disk in a radially outward direction of the recording disk.

5. A ramp member comprising:
a first guiding passage extending backward from a given position along a first inclined plane intersecting with a reference plane by a first inclined angle, said first guiding passage designed to receive a load tab attached to a tip end of a head actuator;
a second guiding passage extending along a second inclined plane at rearward of the first guiding passage, said second inclined plane intersecting with the reference plane by a second inclined angle larger than the first inclined angle; and
a third guiding passage located at rearward of the second guiding passage and extending toward a depression.

6. The ramp member according to claim 5, wherein the second guiding passage is connected to a rear end of the first guiding passage.

7. A ramp member comprising:
a first guiding passage extending backward from a given position and designed to receive at a concave surface a load tab attached to a tip end of a head actuator; and
a second guiding passage located at rearward of the first guiding passage and extending toward a depression.
